(19) United States
(12) Patent Application Publication
(10) Pub. No.: US 2016/0294962 A1
(43) Pub. Date: Oct. 6, 2016

(54) METHODS AND SYSTEMS FOR MANAGEMENT AND CONTROL OF MOBILE DEVICES

(71) Applicant: VONAGE NETWORK LLC, Holmdel, NJ (US)

(72) Inventors: Alexandra Andreev, Akko (IL); Eli Birger, Petah Tikva (IL)

(21) Appl. No.: 14/707,196

(22) Filed: May 8, 2015

Related U.S. Application Data
(60) Provisional application No. 62/140,586, filed on Mar. 31, 2015.

(51) Int. Cl. H04L 29/08; G08B 21/02

(52) U.S. Cl. CPC H04L 67/22; H04L 67/306; G08B 21/0202

(57) ABSTRACT

Methods and systems for intelligently managing and controlling mobile devices are provided herein. In some embodiments, a method for intelligently managing and controlling mobile devices includes receiving information regarding activity performed on a child device, and determining a management and control action to associate with the activity based on (a) the activity performed and (b) previous user behavior patterns associated with the child device, wherein the management and control action includes at least one of notifying at least one parent device of the activity performed or directly controlling the activity of the child device.

### CROSS-REFERENCE TO RELATED APPLICATION

This application claims benefit of U.S. Provisional Patent Application No. 62/140,586 filed Mar. 31, 2015, which is hereby incorporated in its entirety.

### BACKGROUND

1. Field

Embodiments of the present invention generally relate to the management and control of mobile devices, and in particular to a hierarchical control and management of the mobile device life-cycle within organizations and households.

2. Description of the Related Art

Organizations have recognized that mobile devices are crucial to their own success, and many have incurred significant expense purchasing and securing such devices, and equipping their workforce. Nonetheless, employees are increasingly using (or demanding to use) personal devices to store and process their employer's data, and connect to their networks. The reasons for this vary from avoiding the need to carry and manage multiple devices, to the desire to use the most up-to-date devices that exist, to increased efficiency. This use of personal devices is referred to as “COIT” (the Consumerization of Information Technology”) or BYOD (Bring Your Own Device). Some organizations believe that BYOD will allow them to avoid significant hardware, software and IT support costs. Even if cost-savings is not the goal, most companies believe that processing of company data on employee personal devices is inevitable and unavoidable. Unfortunately, BYOD raises significant control, device management, data security and privacy concerns, which can lead to potential legal and liability risk.

Similarly, the increased use of mobile devices that include full featured internet browsers and downloadable applications has created a demand for parental controls on these mobile devices.

There is a need in the industry to provide a practical solution that allows management and control a mobile device of a first party by a second party.

### SUMMARY

Methods and systems for intelligently managing and controlling mobile devices are provided herein. In some embodiments, a method for intelligently managing and controlling mobile devices includes receiving information regarding activity performed on a child device, and determining a management and control action to associate with the activity based on (a) the activity performed and (b) previous user behavior associated with patterns child device, wherein the management and control action includes at least one of notifying at least one parent device of the activity performed or directly controlling the activity of the child device.

In some embodiments, a system for intelligently managing and controlling mobile devices includes a user behavior analysis module configured to determine user behavioral patterns of a child device based on past child device activity information, a rules creation module configured to create one or more rules based on the user behavioral patterns of a child device determined by the user behavior analysis module, and an alert and control module configured to determine management and control actions for a received child device activity information, and configured to at least one of notify at least one parent device of the activity performed or directly control the activity of the child device based on (a) child device activity information and (b) the one or more rules created.

In some embodiments, a method for intelligently managing and controlling mobile devices includes transmitting, by a parent device, one or more rules associated with one or more child devices to be monitored by the parent device, receiving, responsive to a rule condition that is triggered based on child device activity, information regarding activity performed on one of the one or more child devices, and transmitting a management and control action to associate with the activity based on the activity performed, wherein the management and control action includes instructions to directly control the activity of the child device.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for providing intelligent management and control of child devices based on user behavioral activity and content analyses, according to one or more embodiments of the invention;

FIG. 3 is a bubble chart of operations according to one or more embodiments, such as the one in FIG. 2;

FIG. 4 is an exemplary neural network system that may be used for providing intelligent management and control of child devices according to one or more embodiments;

FIG. 5 depicts a flow diagram of a method for providing intelligent management and control of child devices, according to one or more embodiments of the invention;

FIG. 6 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to systems and methods for the management and behavioral control of content on mobile devices, and more specifically, for providing enterprise-level or household-level management of mobile devices supported by various mobile devices and operating systems. In some embodiments, the invention provides this capability by utilizing one or more distributed applications or modules to facilitate interaction with individual mobile devices.

In some embodiments, managing or controlling various “child” devices/accounts from one or more “parent” devices/accounts may include the implementation of specific time limits, black lists (e.g., phone numbers, URLs, content/service providers or other communication identifiers which are blocked), content restrictions, white list (e.g., phone numbers, URLs, content/service providers, or other communication identifiers which have been pre-approved), reports/alerts, and the like. One or more hierarchies of accounts may be defined to implement different control/management schemes. In some embodiments, one or more “parent” accounts/devices would to delegate or share management responsibilities with other accounts/devices. In some embodiments, content may be controlled based on the category or classification of the content (e.g., when content include dangerous or inappropriate material for a given user account). In some embodiments, the determination of what material is dangerous or inappropriate may be based on explicitly entered information/keys or a by a decision mechanism that includes special behavioral and self-learning algorithm which will recognize patterns. As used herein, the “parent” and “child” accounts/devices define a hierarchy of accounts. It may be used in the context of a business enterprise-level organization, for example, data security department devices considered parent or master accounts/devices able to manage/control other devices in an organization). may be considered. In addition, it may be used in the context of household-level management where parents may be able to manage, control and be alerted to device activities performed by their children.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

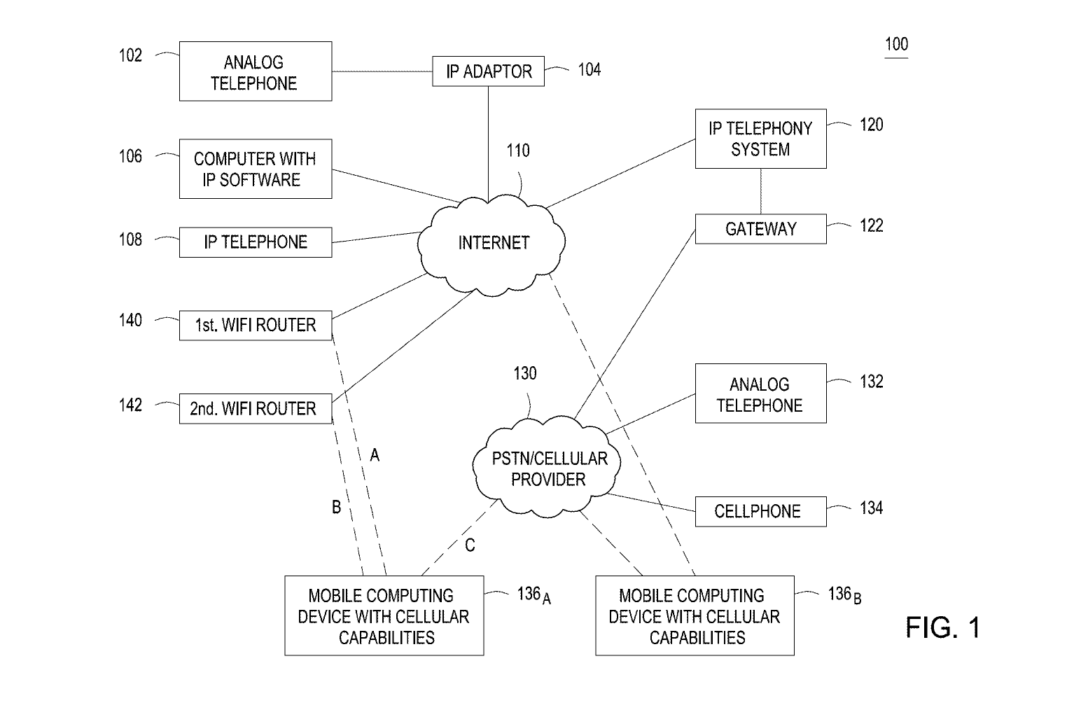

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a wireless local area network (WLAN) router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136B may also be coupled to internet 110 and/or cellular service provider 130. In some embodiments, mobile computing device 136B may be connected to internet 110 via a wireless local area network (WLAN) based on the Institute of Electrical and Electronics Engineers' (IEEE) 802.11 and 802.13 standard connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform. For example, mobile computing device 136A may download a VOIP mobile app from app distribution platform and install the VOIP mobile app on mobile computing device 136A.

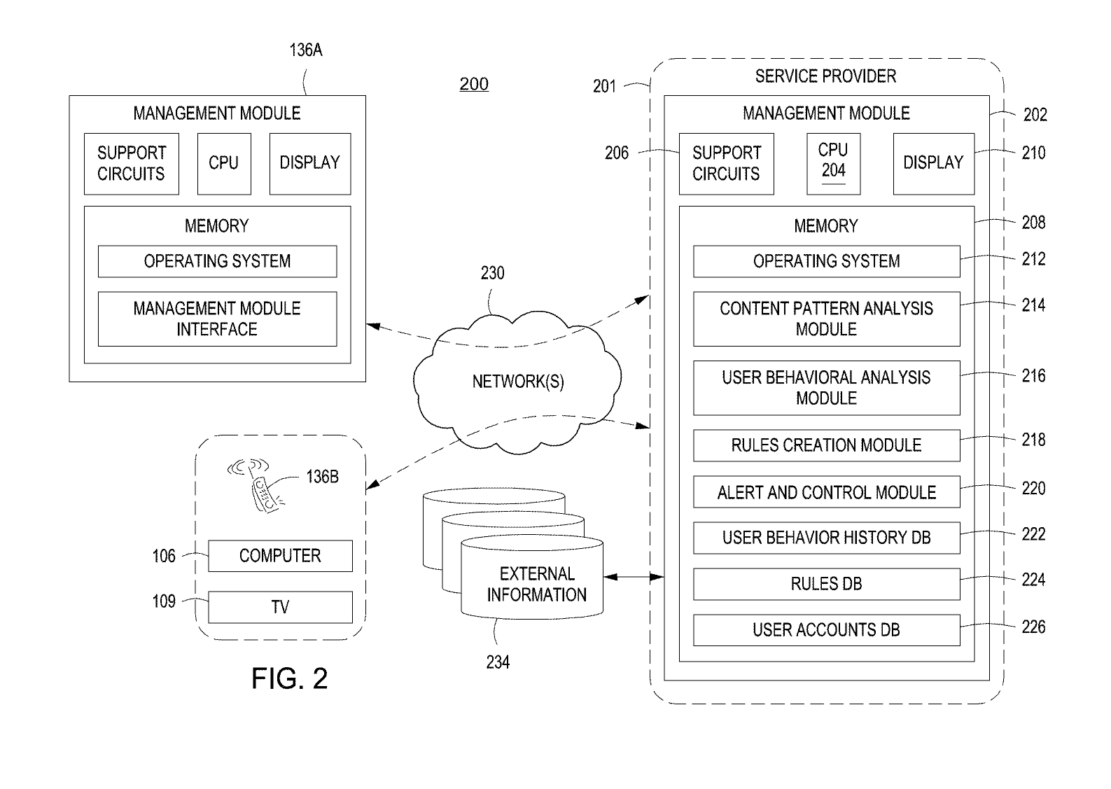

As shown in FIG. 2, the system 200 comprises multiple user devices, such as user devices mobile computing devices 136_{A}, 136_{B}, computer 106, network connected TV 109, and service provider system 201 communicatively coupled via networks 230. in some embodiments a service provider system 201 (e.g., a content provider, social media provider, IP telephony system 120 or PSTN 130, and the like) may include an intelligent management and control system (IMCS) 202 for determining how to alert parent end user devices (e.g., mobile computing device 136_{A}) and manage and control child end user devices (e.g., mobile computing device 136_{B}, computer 106, network connected TV 109, and the like) based on user behavioral analysis and content pattern analysis. Specifically, the IMCS 202 provides the ability for parent accounts/devices to monitor child accounts/devices related to them, and enable control on those child accounts, where the parent device/account can be alerted on atypical or dangerous activities. However, unlike typical parental control systems that exist today, the IMCS 202 provides intelligent management and behavioral control of content on mobile devices to subscribers using rules based on a user's past usage patterns, the current content information (i.e., in-band information), external information (i.e., out-of-band information), and the user's settings/preferences.

The IMCS 202 comprises a Central Processing Unit (CPU) 204, support circuits 206, memory 208, and, in some embodiments, a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output circuits, and the like. The memory 208 comprises at least one of Read Only Memory (ROM), Random Access Memory (RAM), disk drive storage, optical storage, removable storage and/or the like. In some embodiments, the memory 208 comprises an operating system 212, content pattern analysis module 214, user behavioral pattern analysis module 216, rules creation module 218, alert and control module 220, user behavior history database 222, rules database 224, and a user accounts database 226.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, LINUX, MAC OSX, BSD, UNIX, MICROSOFT WINDOWS, 10S, ANDROID and the like.

The networks 230 comprise one or more communication systems that connect computers by wire, cable, fiber optic and/or wireless link facilitated by various types of well-known network elements, such as hubs, switches, routers, and the like. The networks 230 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

Although user behavior history database 222, rules database 224, and a user accounts database 226 are shown as being included in memory 208, those of ordinary skill in the art will recognize these elements may be implemented as separate databases coupled to the IMCS 202. In addition, although content pattern analysis module 214, user behavioral pattern analysis module 216, rules creation module 218, and alert and control module 220 are shown as being included in memory 208, those of ordinary skill in the art will recognize these elements may be implemented as separate systems communicatively coupled to the IMCS 202.

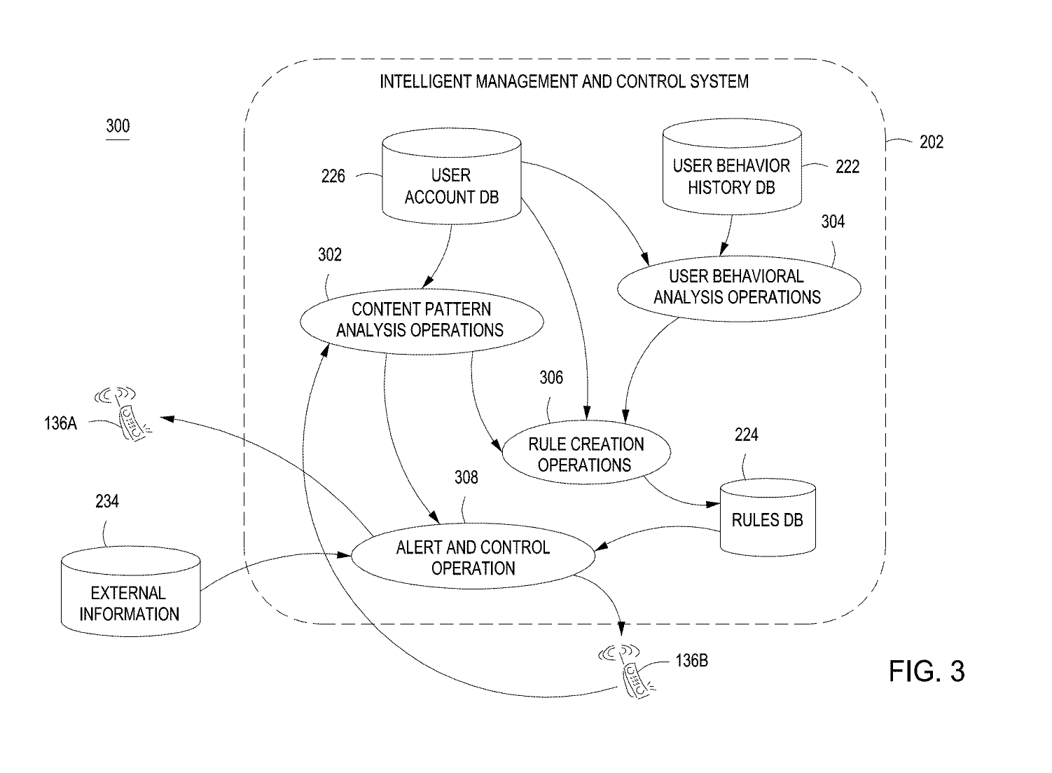

FIG. 3 is a bubble chart 300 of operations of the IMCS 202 in accordance with the embodiments of FIG. 2.

In some embodiments, intelligent management and control services will be provided to users or organizations that have opted into the service. If the user/organization has opted into the intelligent management and control service, a profile will be created for each user identified in user accounts database 226. In some embodiments, a separate profile may not be created, but rather, an existing user account for the users identified will be updated to include the hierarchical information regarding related accounts as well as other IMCS user settings. Once opted in, the user may set their preferences on how various child devices/accounts should be monitored. Parent or master users may also be able to disable, or otherwise override, the intelligent management and control services at any time.

The relationship between parent and child accounts may be established at the time the child account is created. In a business setting, phones/accounts may be provisioned as a child account having one or more parents. In some embodiments, the relationship between parent and child accounts may be established by a request provided by the telephony service provider (e.g., a VoIP service provider).

Once a user is subscribed or identified as a child account in the intelligent management and control service, the history of at least some of their device usage history/activities (i.e., user behavior) will be stored in user behavior history database 222. In some embodiments, device usage history/activities may be saved for all users receiving calls, regardless of whether or not the user subscribes to the intelligent management and control service. The user behavior history database 222 will include detailed information about user usage behavior. For example, some non-limiting examples of the information associated with device usage history/activities include uniform resource locators (URLs) visited, number of pre-identified keywords (e.g., flagged bad words) used, change of geo-location, rate of change of geo-location, number of location changes, hours of usage, addition/deletion of contacts, number of minutes of usage, number of messages sent/received, documents accessed, number of documents sent/received, and the like. Other non-limiting examples may include unusual behavioral patterns such as sudden changes in conversation volume (e.g., yelling, screaming).

User behavioral pattern analysis operations 304 may be performed on user behavior history records from user behavior history database 222 for a subscribed user. User behavioral pattern analysis operations 304 may be performed, for example, by user behavioral pattern analysis module 216. For example, user behavioral pattern analysis operations 304 may include determining that the user has used language identified by a parent device/account as inappropriate or dangerous, or has emailed/uploaded more company documents then they normally send/upload over a defined time period.

User behavioral pattern analysis operations 304 analyze stored user behavior from user behavior history database 222 for a subscribed user and provide the determined user behavior patterns of the user to rules creation operations 306. Rules creation operations 306 may be performed by rules creation module 218. Rules creation operations 306 may include using the user behavior received, or otherwise obtained, in addition to user preferences set by the user and user accounts database 226 to create rules on how to manage, control and be alerted to device activities performed by child devices. In the example above, rules creation operations 306 may receive information from user behavioral analysis operations 304 that the child device has sent a large number of images within the last 2 hours. The rules creation module 218 may further obtain information from user accounts database 226 to determine if the parent account set any threshold limitations on the number of images allowed to be sent in a given time period. For example, the user accounts database 226 may include instructions from the parent account requiring an alert be generated and sent to the parent account when the number of images for a given time period exceeds the threshold set, or that all images should be blocked from being sent until the parent account provides authorization to do so. The rules created by rules creation operations 306 are stored in the rules database 224. Although the user behavioral pattern analysis operations 304 and rules creation operations 306 are described as being performed by user behavioral analysis module 216 and rules creation module 218, these operations may be performed together in a single module to determine user behavioral patterns and rules.

Similarly, in some embodiments, content pattern analysis operations 302 may analyze current content being accessed by the child device (e.g., 136B) for a subscribed child device and provide the determined content patterns of the content accessed, or attempted to be accessed, to rules creation operations 306. Rules creation operations 306 may be performed by rules creation module 218. Rules creation operations 306 may include using the content information received, or otherwise obtained, in addition to user preferences set by the user and user accounts database 226 to create rules on how to manage, control and be alerted to device activities performed by child devices. In the example above, rules creation operations 306 may receive information from content pattern analysis operations 302 that the child device is attempting to access content that may be prohibited by the parent account, such as a specific URL or content that includes inappropriate language, images, or video. The rules creation module 218 may further obtain information from user accounts database 226 to determine if the parent account set any whitelist/blacklist limitations on specific URLs, or types of content that they should be alerted to. The rules created by rules creation operations 306 are stored in the rules database 224. Although the content pattern analysis operations 302 and rules creation operations 306 are described as being performed by user behavioral analysis module 216 and rules creation module 218, these operations may be performed together in a single module to determine content patterns and rules.

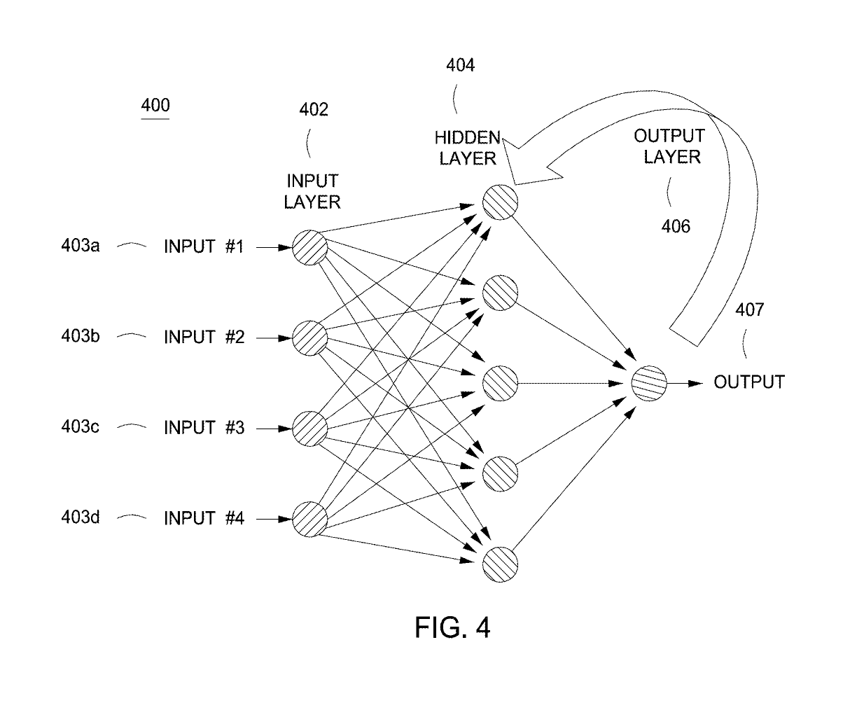

Content pattern analysis operations 302, user behavioral pattern analysis operations 304, and/or rules creation operations 306 may include the use of neural networks to determine and refine calling patterns and rules. That is, the IMCS 202 will employ learning algorithms to be used in content pattern analysis operations 302, user behavioral pattern analysis operations 304, and rules creation operations 306 to determine content and user behaviors, and to create rules associated with the determined behaviors. Specifically, as shown in FIG. 4, an exemplary neural network system 400 that may be used by content pattern analysis operations 302, user behavioral pattern analysis operations 304 and rules creation operations 306. The system 400 may include an input layer 402 and includes a plurality of inputs 403a-d. The inputs (variables) that are chosen may include time of day (at the user's location), day of the week, the child device information, the amount of time the child device has been online, the number and type of communications made by the child device, the types of documents received and sent by the child device, the number of pre-identified keywords used in communications sent and received by the child device, information regarding the contacts that the child device has been in communication with, whether the contacts are in the child device's contact book, the child device's location, motion and activity information of the child device (i.e., was the child device moving when text messages were sent/opened, and the like. The inputs 403a-d of the input layer 402 are obtained from user behavior history database 222 and from current content accessed by the child device (e.g., 136B).

The hidden layer 404 operates on the inputs 403a-d of the input layer 402 to provide behavior patterns. Thus, in embodiments consistent with the present invention, the hidden layer 404 is the result of the call pattern analysis operations 314 performed on inputs 403a-d. That is, based on the inputs 403a-d of the input layer 402, the hidden layer 404 includes the determined call termination behaviors of the user. The output 407 is the end rule based determined by rules creation operations 306 on the given set of inputs 403a-d and the behavior patterns of the hidden layer 404.

Initially, while the system 400 is learning, the system 400 might provide the same output (i.e., do not block or report activity) no matter what the inputs are. However, over time, based on the user's behavior in different circumstances, the system learns the optimal behavior for a given set of circumstances/inputs that resulting in changes in the hidden layer. For example, the system may learn/determine the median volume of conversations, which may be different for different call receivers and users. Feedback based on user's behavior will result in gradual formation and modification of hidden rules. In some embodiments, user behavior activity rules may be suggested to users once the system reaches a threshold level of certainty regarding the given rule. In some embodiments, initial tests are performed to optimize the algorithm and to deduce or estimate how soon can a sufficient certainty level is achieved. For example, the initial tests may indicate that 2 weeks of activity would suffice to reach a sufficient initial certainty level/prediction. This amount of user activity used to reach a threshold level of certainty is further optimized dynamically/on-the-fly based on users' reaction and satisfaction. Thus, the rules database 224 may include a certainty level, or rule weighting, associated with each rule.

Returning to FIG. 3, in operation, when a request to access content from a protected child device (e.g., a mobile computing device 136B, computer 106, TV 109, and the like) is received by content pattern analysis module 214, alert and control operations 308 are performed on the user activity to determine whether the activity should be blocked or otherwise reported to a parent device. In some embodiments, the alert and control operations 308 may automatically run periodically to alert a parent account/device, and/or control the child device, based on a triggered rule from rules DB 224. A triggered rule includes rules that may automatically perform an action when a certain event occurs or a set of conditions is met/matched. For example, a rule may be set that limits the number of images transmitted from the child device to 5 images. Each time an image is sent by the child device, all rules associated with that activity (sending images) will be identified and the condition for the identified rules will be checked. In this example, if the number of images sent exceeds 5 images, the parent device will be notified. The IMCS 202 may automatically block the child device from sending addition images, or the parent device may transmit a management and control action to associated with the activity (e.g., block addition image transmission, increase the threshold, only allow images transmission to pre-authorized group of contacts, etc.) Alert and control operations 308 will use information associated with the content requested/accessed by child device (e.g., 136B), information from user accounts database 226 about the parent account and the child account, and rules from rules database 224. Alert and control operations 308 may first determine if the child device (e.g., 136B) is a device, or associated with an account, that is being protected/monitored by the intelligent management and control service by accessing user accounts database 226. Alert and control operations 308 may then extract in-band information associated with the content requested or the user activity being performed to determine if there are any matching rules from rules database 224. Specifically, alert and control operations 308 may determine from the content requested whether one or more rules from rules database 224 have been matched/triggered.

If no matching rules apply, then a default alert and control procedures may be used. For example, a default alerting procedure may include alerting a parent device if a child device exceeds an amount of device activity time designated by the parent device, or has accessed/emailed company information deemed as proprietary. If alert and control operations 308 determines that the requested content and associated child device activity matches one or more rules in rules database 224, then the parent device may be notified and the child device may be controlled (e.g., content blocked) in accordance with the one or more matching rules.

In some embodiments, alert and control operations 308 may include obtaining out-of-band information from external sources 234. The external sources 234 from which the out-of-band information is obtained may include, for example, calendar applications and social media sources such as, for example, LINKEDIN, FACEBOOK, Global Positioning Satellite (GPS) information from GPS services, and the like. For example, alert and control operations 308 may take into account calendar information such as school holidays to determine whether a child device has triggered a rule. Specifically, a parent device may indicate that a child device may not be used midweek during school hours for more than a few minutes, except if it is a holiday, at which point the time limits don't apply.

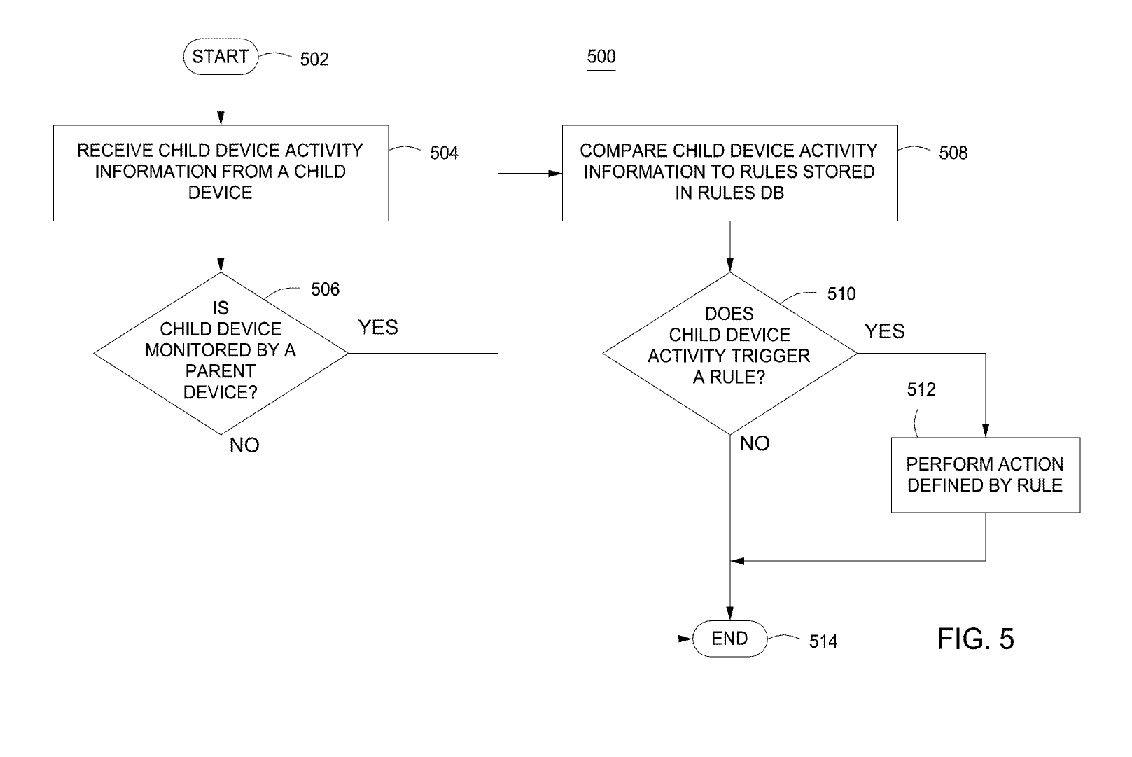

FIG. 5 depicts a flow diagram of a method 500 for providing intelligent management and control based on user behavior on a child device, according to one or more embodiments of the subject invention.

The method begins at 502 and proceeds to 504 where information regarding child device activity is received. In some embodiments, the child device activity information may be in the form of a content request (e.g., HTTP request include a URL), a call request, a text message, an email message, app usage information. The child device activity information may be received a part of a Session Initiation Protocol (SIP) message, Signaling System No. 7 (SS7) message, Short Message Service (SMS) or Multimedia Messaging Service (MMS) message, a User Datagram Protocol (UDP) message or other type of message. In some embodiments, the information regarding the child device activity may be received with a child device activity record that is periodically sent to the IMCS 202 for analysis and storage. In some embodiments, the child device activity information may be received by content pattern analysis module 214 and/or user behavioral analysis module 216 of IMCS 202.

At 506, it is determined whether the child device is a device that has been identified by a parent device/account for monitoring, management and control. IMCS 202 may access user accounts database 226 to determine whether the child device is to be monitored, managed, and/or controlled. If the child device is not identified as a device that should be monitored, managed, and/or controlled, the method ends at 514. If it is determined at 506 that the child device is a device that has been identified by a parent device/account for monitoring, management and control, the method 500 proceeds to 508 where the child device activity information is compared to rules stored in rules database 224. For example, if a child device attempts to access a specific URL, that URL may be searched in the rules database 224 to see if it is included as part of a blacklist or whitelist. As another example, the child device activity information may include content of a message (such as a text or email message) that is analyzed to determine if the message content matches keywords identified as inappropriate in the rules DB.

At 510, if the child device activity information does not match any rule stored in the rules database method ends at 514. However, if at 510 it is determined that the child device activity information triggers a rule, the rule action associated with the identified rule is performed at 512. The rule action associated with the rule may include notifying a parent account/device of the child device activity information. In some embodiments, information about the rule triggered is also provided to the parent account/device. In some embodiments, the rule action may include direct control of the child device such as, for example, blocking access to the content requested, blocking a call or text message that includes inappropriate language, blocking the sending/dissemination of documents deemed to be proprietary a company, and the like. The method 500 ends at 514.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

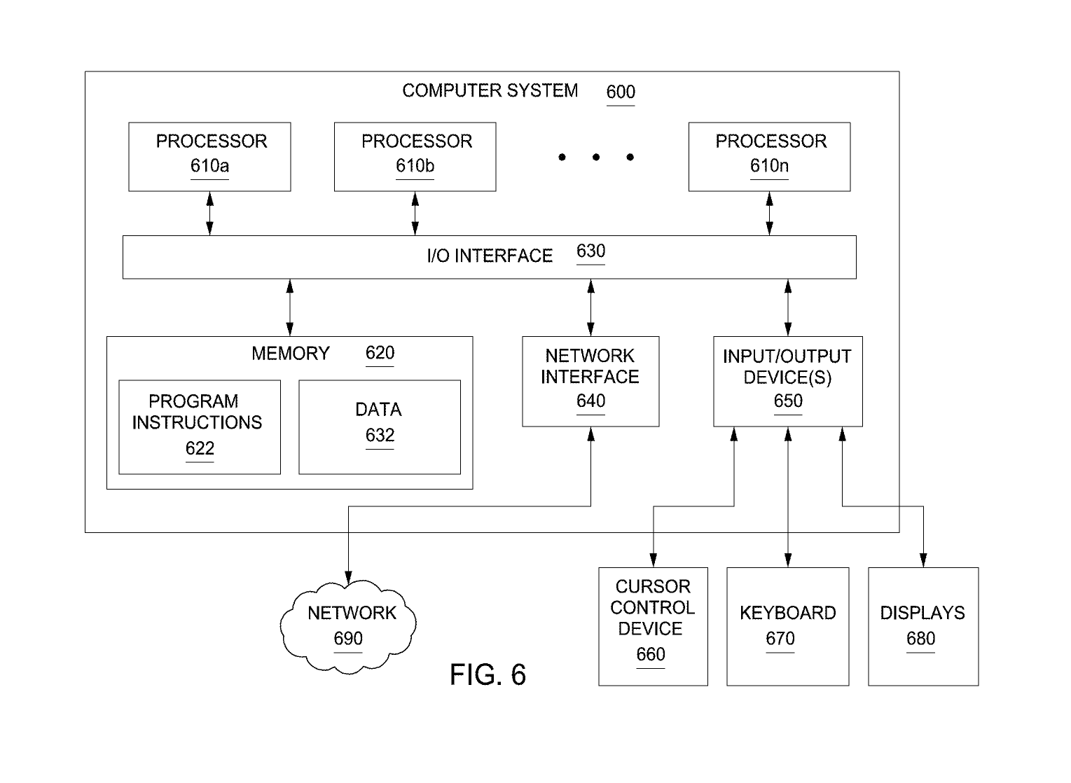

FIG. 6 depicts a computer system 600 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 600 illustrated by FIG. 6, which may in various embodiments implement any of the elements or functionality illustrated in FIGS. 1-5C. In various embodiments, computer system 600 may be configured to implement methods described above. The computer system 600 may be used to implement any other system, device, element, functionality or method of the above-described embodiments. In the illustrated embodiments, computer system 600 may be configured to implement methods 500 and 550 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the operations described with respect to FIG. 3 and the methods illustrated by the flowcharts of FIGS. 5A-5C. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for intelligently managing and controlling mobile devices, comprising:
receiving information regarding activity performed on a child device; and
determining a management and control action to associate with the activity based on (a) the activity performed and (b) previous user behavior patterns associated with the child device, wherein the management and control action includes at least one of notifying at least one parent device of the activity performed or directly controlling the activity of the child device.

2. The method of claim 1, wherein the previous user behavioral patterns on the child device are determined by an analysis of past child device activity.

3. The method of claim 2, wherein the information regarding activity performed by the child device includes at least one of information regarding specific uniform resource locators (URL) visited, number of pre-identified keywords used in a communication, geo-location information of the child device, rate of change of a location of the child device, a number of location changes, time of usage of the child device, additions and/or deletions of contacts on the child device, data usage on the child device, type and/or number of communications sent and received, information associated with documents accessed, transmitted and/or received by the child device, or number of documents accessed, transmitted and/or received.

4. The method of claim 1, further comprising:
storing the information associated with the child device in a user behavior history database.

5. The method of claim 1, wherein determining the management and control action to associate with the activity is further based on rules set up in at least one parent account associated with the at least one parent device.

6. The method of claim 1, wherein the child device is associated with one or more parent accounts in a user account database.

7. The method of claim 6, wherein each of the one or more parent accounts in the user account database specifies different control and management schemes for the child device.

8. The method of claim 6, wherein a first parent account of the one or more parent accounts in the user account database specifies at least one other parent account to delegate control and management responsibilities of the child device.

9. The method of claim 1, wherein determining the management and control action to associate with the information regarding activity performed on a child device is further based on external information from third party services.

10. The method of claim 9, wherein the external information from third party services includes at least one of Global Positioning Satellite (GPS) information from GPS services, information for social media services, or information from external calendar sources associated with the child device.

11. The method of claim 1, wherein the previous user behavioral patterns are determined via a neural network.

12. The method of claim 11, wherein determining the management and control action includes comparing the information associated with the activity performed on a child device and rules created from the previous user behavioral patterns associated with the child device.

13. The method of claim 1, wherein determining the management and control action further includes analyzing content of a communication or document sent or received by the child device.

14. The method of claim 13, further comprising:
determining that the content of the communication or document sent or received by the child device includes language identified by at least one parent account associated with the at least one parent device as inappropriate or dangerous; and
notifying the at least one parent device of a type of communication or document sent or received and the language used.

15. The method of claim 1, where determining a management and control action to associate with the activity includes blocking the child device from performing the activity.

16. A system for intelligently managing and controlling mobile devices, comprising:
a user behavior analysis module configured to determine user behavior patterns of a child device based on past child device activity information;
a rules creation module configured to create one or more rules based on the user behavior patterns of a child device determined by the user behavior analysis module; and
an alert and control module configured to determine management and control actions for a received child device activity information, and configured to at least one of notify at least one parent device of the activity performed or directly control the activity of the child device based on (a) child device activity information and (b) the one or more rules created.

17. The system of claim 16, further comprising:
a user behavior history database that stores past child device activity information;
a rules database that stores the rules created by the rules creation module; and
a user accounts database that stores information associated with the child device and at least one parent account associated with the at least one parent device.

18. The system of claim 17, the user behavior analysis module includes a neural network configured to determine user behavioral patterns of the child device based on past child device activity stored in the user behavior history database.

19. The system of claim 16, further comprising:
a content pattern analysis module configured to determine content patterns of information accessed by a child device.

20. A method for intelligently managing and controlling mobile devices, comprising:
transmitting, by a parent device, one or more rules associated with one or more child devices to be monitored by the parent device;
receiving, responsive to a rule condition that is triggered based on child device activity, information regarding activity performed on one of the one or more child devices; and
transmitting a management and control action to associate with the activity based on the activity performed, wherein the management and control action includes instructions to directly control the activity of the child device.

21. The method of claim 20, wherein the rules include one or more thresholds associated with child device activity.
